(19) United States
(12) Patent Application Publication
(10) Pub. No.: US 2011/0131426 A1
(43) Pub. Date: Jun. 2, 2011

(54) INFORMATION PROCESSING APPARATUS AND CONTROL METHOD OF THE INFORMATION PROCESSING APPARATUS

(75) Inventors: Wataru Nakanishi, Ome-shi (JP); Shigeo Hayashi, Hamura-shi (JP)

(73) Assignee: KABUSHIKI KAISHA TOSHIBA, Tokyo (JP)

(21) Appl. No.: 12/956,373

(22) Filed: Nov. 30, 2010

(30) Foreign Application Priority Data
Nov. 30, 2009 (JP) 2009-272632

(51) Int. Cl. G06F 1/26

(52) U.S. Cl. 713/300

(57) ABSTRACT

According to one embodiment, an information processing apparatus includes a connector, a switching module and a controller. The connector is configured to connect an external device. The switching module is configured to switch between output of electric power to a power supply line, which is connected to the connector, and input of electric power from the power supply line. The controller is configured to make the switching module switch to output of electric power to the power supply line and determine whether the external device includes an electric power supply function when the external device is connected to the connector, and to make the switching module switch to input of electric power from the power supply line when the external device includes an electric power supply function.

### CROSS-REFERENCE TO RELATED APPLICATIONS

This application is based upon and claims the benefit of priority from Japanese Patent Application No. 2009-272632, filed Nov. 30, 2009; the entire contents of which are incorporated herein by reference.

### FIELD

Embodiments described herein relate generally to a power supply technique suitable for, for example, personal computers to receive electric power supplied from an external device connected to a connector thereof, by diverting a power supply line to supply power to the external device connected to the connector.

### BACKGROUND

In recent years, notebook personal computers which can be powered by batteries and are easily portable have become widespread. Computers of this type have been downsized and weights thereof have been reduced, in consideration of easy portability. So, the main body of the computers is equipped with only basic function, and provided with a connector to expand the function to various functions as desired.

For example, a Universal Serial Bus (USB) connector can conduct a power supply line between the computer and an external device connected to the USB connector, and thus can operate the external device by supplying power from the computer to the external device through the USB connector.

In addition, recently, various mechanisms have been proposed to supply power from an external device to the computer through the USB connector conversely from the above case, to charge batteries in the computer (for example, see Jpn. Pat. Appln. KOKAI Pub. No. 2009-151488).

In the meantime, recent computers are equipped with a mechanism which automatically incorporates external devices, which are connected to the computer while the computer is operated, into the system, which is referred to as “Plug and Play” (PnP), as standard mechanism. Therefore, when an external device is connected to the computer while the computer is operated, it is controlled such that power supply from the computer to the external device is automatically started.

Therefore, mechanisms to supply power from an external device through a USB connector, which have been proposed up to now, including Jpn. Pat. Appln. KOKAI Pub. No. 2009-151488 mentioned above, generally perform control to input power from the external device, when the external device including a power supply function is connected to the USB connector when the computer is in a power-off state, to avoid collision between input and output of power. Therefore, in prior art, it is impossible to connect an external device including a power supply function to a USB connector of a computer while the computer is operated, and supply power to the computer from the external device.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary diagram illustrating an outside appearance of an information processing apparatus according to an embodiment.

FIG. 2 is an exemplary diagram illustrating schematic structures of the information processing apparatus of the embodiment and a solar battery unit connected to the information processing apparatus.

FIG. 3 is an exemplary diagram illustrating a structure of an input/output control circuit included in the information processing apparatus of the embodiment.

FIG. 4 is an exemplary flowchart illustrating an operation procedure when an external device is connected to a USB connector of the information processing apparatus of the embodiment.

### DETAILED DESCRIPTION

Various embodiments will be described hereinafter with reference to the accompanying drawings.

In general, according to one embodiment, an information processing apparatus includes a connector, a switching module and a controller. The connector is configured to connect an external device. The switching module is configured to switch between output of electric power to a power supply line, which is connected to the connector, and input of electric power from the power supply line. The controller is configured to make the switching module switch to output of electric power to the power supply line and determine whether the external device includes an electric power supply function when the external device is connected to the connector, and to make the switching module switch to input of electric power from the power supply line when the external device includes an electric power supply function.

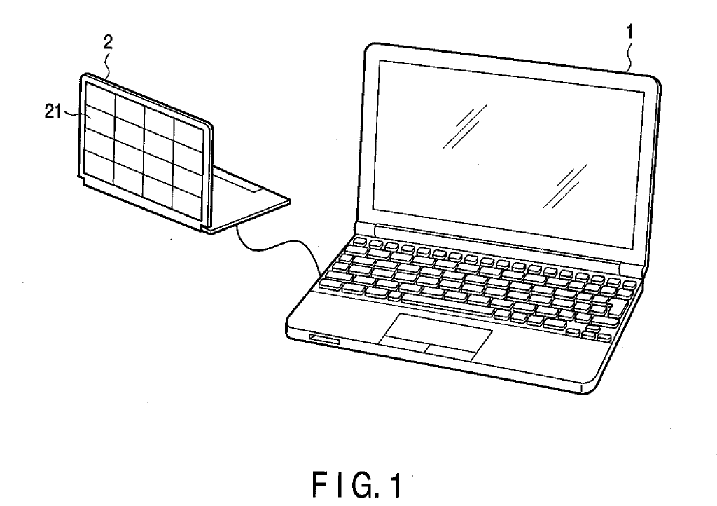

FIG. 1 is an exemplary diagram illustrating an outside appearance of an information processing apparatus according to the embodiment. This information processing apparatus 1 is realized as, for example, a notebook personal computer (PC) which can be driven by batteries. A USB connector (not shown) to connect an external device 2 with the computer is provided in a peripheral wall portion of the main body of the apparatus 1.

The external device 2 illustrated in FIG. 1 is a solar cell unit which includes a solar battery panel 21, and can generate electricity by sunlight. According to the computer 1, it is possible to connect the solar cell unit 2 to the USB connector even when the user is using the computer, that is, the computer is operated, to charge batteries by receiving power supply from the solar battery unit 2 and operate by the power. This point is detailed below. Although this embodiment is explained with an example in which the external device is a solar battery unit, the external device is not limited to solar battery units, but external devices of any type can be applied, as long as they are external devices including a power supply function, such as external battery packs.

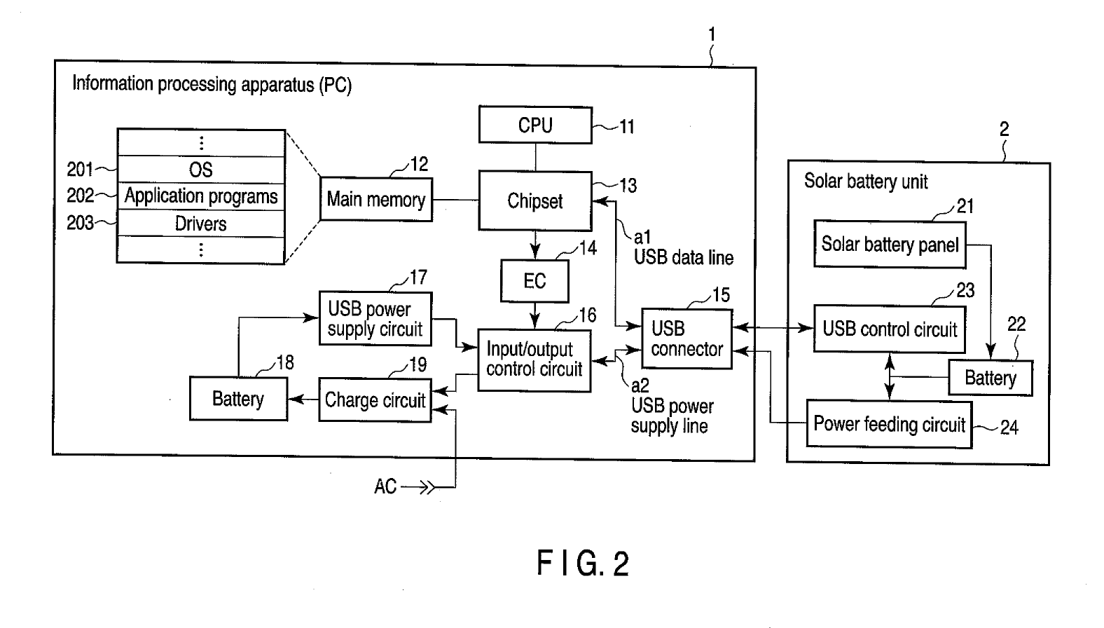

FIG. 2 is an exemplary diagram illustrating schematic structures of the computer 1 of the embodiment and the solar battery unit 2 connected to the computer 1.

As illustrated in FIG. 2, the computer 1 includes a CPU 11, a main memory 12, a chipset 13, an embedded controller (EC) 14, a USB connector 15, an input/output control circuit 16, a USB power supply circuit 17, a battery 18, and a charge circuit 19.

The CPU 11 is a processor which manages operation control of the computer 1, and executes various programs loaded into the main memory 12. The various programs include an operating system (OS) 201 which performs resource management of the computer 1, application programs 202 which operate under the control of the OS 201, and drivers 203 to perform operation control for various devices being hardware from software. The application programs 202 include a power management utility program to properly switch input and output of the power (through the USB connector 15) when the solar battery unit 2 is connected to the USB connector 15. In addition, the drivers 203 include a driver for the solar battery unit 2 to drive and control the solar battery unit 2 connected to the USB connector 15.

The chipset 13 is a bridge device which relays reception and transmission of data performed between the CPU 11, the main memory 12 and various devices. A USB data line “a1” which conducts to the external device 2 connected to the USB connector 15 continues to the chipset 13.

The EC 14 is a controller to transmit operations of the keyboard and the pointing device to the CPU 11. The EC 14 includes a function of starting/stopping the computer 1, in response to on/off operations of the power button. In addition, the EC 14 includes an interface to drive and control the input/output control circuit 16.

A USB power supply line “a2” which conducts to the external device 2 connected to the USB connector 15 continues to the input/output control circuit 16. The input/output control circuit 16 is a switching circuit to exclusively perform output of power to the USB power supply line “a2” and input of power from the USB power supply line “a2”.

The USB power supply circuit 17 is a circuit which generates power to be output to the USB power supply line “a2” by using power from the battery 18. The battery 18 is a secondary battery which can be repeatedly charged and discharged. The charge circuit 19 is a circuit which charges the battery 18 by using power input from the USB power supply line “a2”. Power from an external commercial power supply is input to the charge circuit 19 when it is connected with an AC adapter, and the charge circuit 19 can charge the battery 18 by using the power from the external commercial power supply.

On the other hand, the solar battery unit 2 which is connected to the USB connector 15 of the computer 1 including the above structure includes a solar battery panel 21, a battery 22, a USB control circuit 23, and a power feeding circuit 24.

The battery 22 is a secondary battery to store electricity generated by the solar battery panel 21. The power feeding circuit 24 outputs power from the battery 22 to the USB power supply line “a2” conducting to the computer 1, under control by the USB control circuit 23.

The USB control circuit 23 is a circuit which manages operation control of the solar battery unit 2, and includes a function of performing communication with the computer 1 through the USB data line “a1” conducting to the computer 1. By performing communication between the USB control circuit 23 and the computer 1, the solar battery unit 2 can operate as a usual USB device (as viewed from the computer 1).

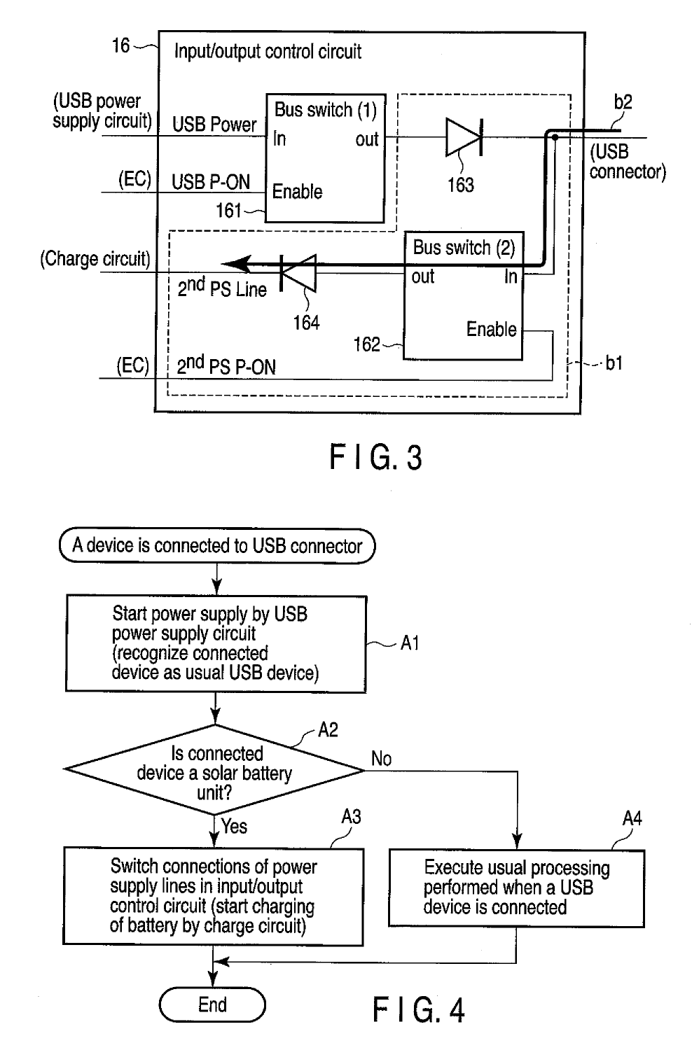

In addition, FIG. 3 is an exemplary diagram illustrating a structure of the input/output control circuit 16 included in the computer 1.

As illustrated in FIG. 3, the input/output control circuit 16 includes two bus switches 161 and 162, and two backflow prevention circuits (diodes) 163 and 164.

The bus switch 161 is provided on a power supply line which is laid in the input/output control circuit 16 to lead power generated by the USB power supply circuit 17 to the USB power supply line “a2”, and opens or shut off the power supply line on the basis of a control signal (presence/absence of supply of an enable signal) supplied from the EC 14. The backflow prevention circuit 163 is provided on the output side of the bus switch 161.

In addition, the bus switch 162 is provided on a power supply line which is laid in the input/output control circuit 16 to lead power input from the USB power supply line “a2” to the charge circuit 19, and opens or shut off the power supply line on the basis of a control signal (which is different from the control signal input to the bus switch 161) (presence/absence of supply of an enable signal) supplied from the EC 14. The backflow prevention circuit 164 is provided on the output side of the bus switch 162.

The input/output control circuit 16 forms a path from the USB power supply line “a2” to the charge circuit 19 indicated by an arrow “b2”, while preventing bad influence on the existing path from the USB power supply circuit 17 to the USB power supply line “a2”, by establishing a part enclosed by a broken line “b1” in FIG. 3, that is, the bus switch 162, the two backflow prevention circuits 163 and 164, and the power supply line to lead power input from the USB power supply line “a2” to the charge circuit 19.

The following is an explanation of an operation principle of the computer 1 when the solar battery unit 2 is connected to the USB connector 15.

When the solar battery unit 2 is connected to the USB connector 15, the USB data line “a1” becomes conductive to the solar battery unit 2, and thus the chipset 13 senses that any external device 2 is connected to the USB connector 15. The chipset 13 which has sensed that any external device 2 is connected to the USB connector 15 generates an interruption signal, and transmits it to the CPU 11. Thereby, the OS 201 recognizes that any external device 2 is connected to the USB connector 15.

The OS 201, which has recognized that any external device 2 is connected to the USB connector 15, issues an instruction to the EC 14 first to drive and control the input/output control circuit 16 to turn on the bus switch 161 and turn off the bus switch 162, to start power supply to the external device 2 connected to the USB connector 15. The EC 14 which has received the instruction supplies an enable signal only to the bus switch 161 of the input/output control circuit 16, and thereby starts power supply to the external device 2 connected to the USB connector 15.

Next, the OS 201 communicates with the external device 2 through the USB data line “a1”, recognizes the connected external device 2, and starts the application program 202 which is correlated with the external device 2 in advance. In this case, by communicating with the USB control circuit 23 of the solar battery unit 2, the OS 201 recognizes that the external device 2 connected to the USB connector 15 is the solar battery unit 2, and starts the power management utility program.

Specifically, also in the computer 1 of the present embodiment, the solar battery unit 2 connected to the USB connector 15 is once recognized as a usual USB device (which is operated by power supplied from the computer 1).

The power management utility program started by the OS 201 (as the solar battery unit 2 is connected to the USB connector 15) issues an instruction to the EC 14 first, through the OS 201, to drive and control the input/output control circuit 16 to turn off the bus switch 161 and turn on the bus switch 162, to prepare the computer 1 to receive power supply from the solar battery unit 2. The EC 14 which has received the instruction stops supplying the enable signal to the bus switch 161 of the input/output control circuit 16, and starts supplying an enable signal to the bus switch 162 of the input/output control circuit 16. Thereby, the path indicated by the arrow “b2” in FIG. 3 is selected, and replaces the path from the USB power supply circuit 17 to the USB power supply line “a2”.

Next, through the driver for the solar battery unit 2, the power management utility program issues an instruction to the USB control circuit 23 of the solar battery unit 2 to output power to the USB power supply line “a2”. Thereby, power from the solar battery unit 2 is led to the charge circuit 19 through the USB connector 15 and the input/output control circuit 16, and the battery 18 is charged, or the computer 1 is operated by using the power.

Although this embodiment shows an example in which the solar battery unit 2 starts output of power to the USB power supply line “a2” in response to an instruction from the computer 1, the solar battery unit 2 may automatically start output of power to the USB power supply line “a2” instead, when input of power from the USB power supply line “a2” is stopped. In this case, the power management utility program may only issue an instruction to the EC 14 to drive and control the input/output control circuit 16 to turn off the bus switch 161 and turn on the bus switch 162.

FIG. 4 is an exemplary flowchart illustrating an operation procedure of the computer 1 when external device 2 is connected to the USB connector 15.

When external device 2 is connected to the USB connector 15, the computer 1 recognizes the external device 2 as a usual USB device first, and establishes the power supply lines in the input/output control circuit 16, to start power supply by the USB power supply circuit 17 (Block A1).

Thereafter, when the external device 2 connected to the USB connector 15 is solar battery unit 2 (YES in Block A2), the computer 1 switches the power supply lines in the input/output control circuit 16, and starts charging of the battery 18 by the charge circuit 19, using power input from the solar battery unit 2 (Block A3).

On the other hand, when the external device 2 connected to the USB connector 15 is not solar battery unit 2 (NO in Block A2), the computer 1 maintains power supply by the USB power supply circuit 17, and executes usual processing performed when a USB device is connected (Block A4).

As described above, the computer 1 includes an original mechanism of temporarily dealing with the solar battery unit 2 connected to the USB connector 15 equally with usual USB devices, and thereby enables receiving power supply from the external device (solar battery unit) 2 connected to the USB connector 15 even when the computer 1 is operated, by using the USB power supply line “a2” to supply power to the external device 2 connected to the USB connector 15.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a connector configured to connect to an external device;
a switching module configured to switch between output of electric power to a power supply line and input of electric power from the power supply line, the power supply line being connected to the connector; and
a controller configured to make the switching module switch to output of electric power to the power supply line and to determine whether the external device includes an electric power supply function when the external device is connected to the connector, and to make the switching module switch to input of electric power from the power supply line when the external device includes an electric power supply function.

2. The apparatus of claim 1, wherein the switching module comprises:
a first switch configured to open or shut off a first internal power supply line to output electric power to the power supply line; and
a second switch configured to open or shut off a second internal power supply line to input electric power from the power supply line.

3. The apparatus of claim 2, wherein the controller is configured to make the first switch open the first internal power supply line and make the second switch shut off the second internal power supply line when the external device is connected to the connector and to make the first switch shut off the first internal power supply line and make the second switch open the second internal power supply line when the external device is a device including an electric power supply function.

4. The apparatus of claim 2, further comprising:
a battery which can be charged and discharged;
a power supply module configured to generate electric power to be output to the power supply line by using electric power from the battery; and
a charge module configured to charge the battery by using electric power input from the power supply line, wherein:
the first internal power supply line leads the electric power generated by the power supply module to the power supply line, and
the second internal power supply line leads the electric power input from the power supply line to the charge module.

5. The apparatus of claim 4, wherein the switching module comprises:
a first backflow prevention module provided on the first internal power supply line; and
a second backflow prevention module provided on the second internal power supply line.

6. The apparatus of claim 5, wherein:
the first backflow prevention module is interposed between the first switch and the power supply line, and
the second backflow prevention module is interposed between the second switch and the charge module.

7. A control method of an information processing apparatus comprising a connector configured to connect to an external device and a switching module configured to switch between output of electric power to a power supply line, which is connected to the connector, and input of electric power from the power supply line, the method comprising:
making the switching module switch to output of electric power to the power supply line and determining whether the external device includes an electric power supply function when the external device is connected to the connector; and
making the switching module switch to input of electric power from the power supply line when the external device includes an electric power supply function.
